(19) United States
(12) Patent Application Publication
(10) Pub. No.: US 2016/0044039 A1
(43) Pub. Date: Feb. 11, 2016

(54) PRIVACY-AWARE PERSONAL DATA STORE

(71) Applicants: Alessandro Montanari, Dublin (IE); Afra Mashhadi, Dublin (IE); Aidan Boran, Meath (IE); Fahim Kawsar, Antwerp (BE)

(72) Inventors: Alessandro Montanari, Dublin (IE); Afra Mashhadi, Dublin (IE); Aidan Boran, Meath (IE); Fahim Kawsar, Antwerp (BE)

(73) Assignee: Alcatel Lucent, Boulogne-Billancourt (FR)

(21) Appl. No.: 14/454,174

(22) Filed: Aug. 7, 2014

(51) Int. Cl. H04L 29/06; G06F 21/62

(52) U.S. Cl. CPC H04L 63/10; G06F 21/62; G06F 2221/2145

(57) ABSTRACT

A capability for privacy-aware personal data storage is presented. The capability for privacy-aware personal data storage enables secure storage of data within a personal data store. The data stored in the personal data store may be data produced by a set of connected end devices associated with an entity for which the personal data store stores data of the set of connected end devices. The capability for privacy-aware personal data storage may support visualization of and control over privacy level for data of a connected end device(s) that is stored in the personal data store. The visualization of and control over data stored in the personal data store may be supported by a privacy meter, which may be an object or device that may be integrated with or independent of the connected end device(s) for which the visualization of and control over data stored in the personal data store is supported.

### TECHNICAL FIELD

The disclosure relates generally to storage of personal data and, more specifically but not exclusively, to privacy-aware storage of personal data.

### BACKGROUND

The use of smart devices, such as smartphones, ubiquitous computing devices, and so forth, continues to grow. This growth is being accelerated as Internet of Things (IoT) applications and other similar applications become more mainstream and more widely adopted. The use of smart devices generally facilitates a variety of rich experiences in our lives, improving access to computing, providing home automation, facilitating various functions in public spaces, and the like. Additionally, the use of smart devices typically also results in collection of data that is produced by or about people.

The collected data may be explicitly produced by users themselves (e.g., taking pictures or video, sharing location information, or the like), implicitly inferred by sensing capabilities (e.g., tracking location information, monitoring residential energy consumption, monitoring noise levels, or the like), and so forth. As such data continues to be collected, it raises various significant concerns regarding the privacy of users with which such collected data is associated, especially given availability of and constant improvements in algorithms configured to mine such data in order to determine or infer various types of information about the users (e.g., lifestyle, behavior, or the like).

For example, there are many algorithms that are configured to mine such collected data in order to determine or infer various types of information about the users (e.g., lifestyle, behavior, or the like). Disadvantageously, however, most users are not aware of the types of data being collected or the associated information being determined or inferred from such data, or the potential uses of the types of data being collected or the associated information being determined or inferred from such data.

Similarly, for example, many smart devices offer services and analytics configured to operate on the data being collected, which may provide improved functionality, services, and so forth. Disadvantageously, however, with such an unprecedented increase in the functionality available from such smart devices, most users are unable to understand how the data that is being collected, or the associated information being determined or inferred from such data, is being used and whether their privacy is at risk.

Accordingly, there is a need for improvements in privacy related to use of smart devices and other similar types of devices.

### SUMMARY OF EMBODIMENTS

Various deficiencies in the prior art may be addressed by embodiments for supporting a privacy-aware personal data store.

In at least some embodiments, a personal data store is provided. The personal data store includes a processor and a memory communicatively connected to the processor. The processor is configured to receive, at the personal data store, data from a connected end device associated with a network server, where the network server is an intended consumer of the data from the connected end device. The processor is configured to securely store the data from the connected end device in the personal data store. The processor is configured to propagate at least a portion of the securely stored data from the personal data store toward the network server based on data access control information associated with the securely stored data.

In at least some embodiment, a method for use by a personal data store is provided. The method includes receiving, via a processor of the personal data store, data from a connected end device associated with a network server, where the network server is an intended consumer of the data from the connected end device. The method includes securely storing the data from the connected end device in the personal data store. The method includes propagating at least a portion of the securely stored data from the personal data store toward the network server based on data access control information associated with the securely stored data.

In at least some embodiments, an apparatus configured to support a personal data store is provided. The apparatus includes a first module configured to control configuration of a connected end device to communicate with the personal data store and store data of the connected end device within the personal data store. The apparatus includes a second module configured to control access to data of the connected end device stored in the personal data store. The first module may be configured to receive, from the connected end device, a request to connect to the personal data store, and propagate, toward the connected end device, information configured for use by the connected end device to connect to the personal data store. The second module may be configured to receive, from a network server, a request to access data of the connected end device stored in the personal data store, and propagate, toward the network server based on a determination that an entity controlling the personal data store has authorized access by the network server to the data of the connected end device stored in the personal data store, information configured for use by the network server to connect to the personal data store. The apparatus may include a third module configured to operate as a gateway between the personal data store and a network server attempting to access the data of the connected end device stored in the personal data store. The third module may include an application programming interface (API) configured to provide a description of the data of the connected end device stored in the personal data store, a privacy threat evaluation module configured to monitor a subscription by a network server to data of the connected end device stored in the personal data store and to determine whether there is a privacy threat associated with the subscription by the network server to the data of the connected end device stored in the personal data store, and a privacy semantic module configured to estimate a privacy level of the data of the connected end device stored in the personal data store.

In at least some embodiments, a privacy meter is provided. The privacy meter includes a presentation interface configured to present a visual indicator indicative of a privacy level of data of a connected end device stored in a personal data store. The privacy meter includes an interaction interface configured to accept an indicator of a modification of the privacy level of the data of the connected end device stored in the personal data store. The privacy meter includes a processor communicatively connected to the presentation interface and the interaction interface. The processor is configured to receive, from a network element, an indication of the privacy level of the data of the connected end device stored in the personal data store and control presentation of the visual indicator indicative of the privacy level of data of the connected end device stored in the personal data store. The processor is configured to receive the indicator of the modification of the privacy level of the data of the connected end device stored in the personal data store and propagate, toward at least one of the personal data store or the network element, a request for modification of the privacy level of the data of the connected end device stored in the personal data store.

### BRIEF DESCRIPTION OF THE DRAWINGS

The teachings herein can be readily understood by considering the following detailed description in conjunction with the accompanying drawings, in which:

FIG. 1 depicts an exemplary system including a privacy-aware personal data store configured to securely store and control access to data from connected end devices;

FIG. 2 depicts an exemplary embodiment of a method for using a privacy-aware personal data store to securely store and control access to data from connected end devices;

FIG. 3 depicts an exemplary system, including a privacy-aware personal data store, configured to support privacy monitoring, feedback, and control capabilities for the privacy-aware personal data store;

FIG. 4 depicts an exemplary interface of a privacy meter configured to support privacy monitoring, feedback, and control capabilities for the privacy-aware personal data store;

FIG. 5 depicts an exemplary embodiment of a method for supporting privacy monitoring, feedback, and control capabilities for a privacy-aware personal data store; and

FIG. 6 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

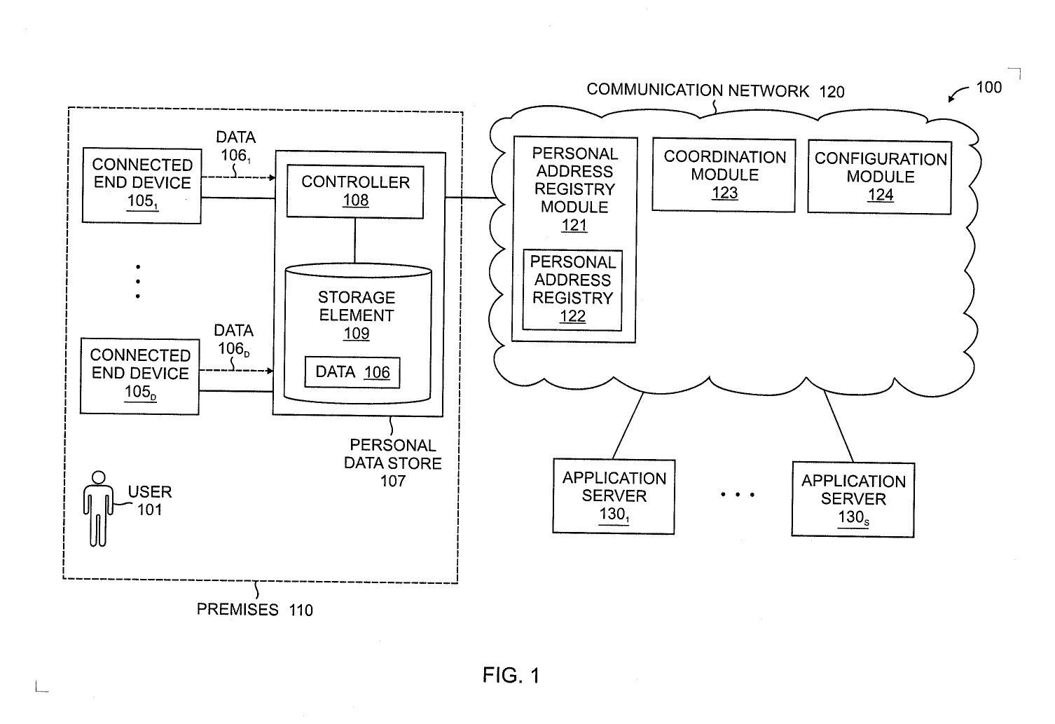

In general, a capability for privacy-aware personal data storage is presented. The capability for privacy-aware personal data storage enables secure storage of data of an entity (e.g., a user, a group of users, an institution, or the like) within a personal data store of the entity. The data stored in the personal data store of the entity may be data produced by a set of connected end devices associated with the entity (e.g., within an environment associated with the entity, such as a home, business, or other environment). The capability for privacy-aware personal data storage may support control over access to and sharing of data of the entity that is stored in the personal data store of the entity. The data of the entity that is stored securely in the personal data store of the entity may be accessed by external entities (e.g., entities external to the environment of the entity of the personal data store) based on data access control information associated with the securely stored data. The data access control information may be set by the entity such that the entity has control over access to the data of the personal data store. The capability for privacy-aware personal data storage may support dynamic visualization of and control over privacy levels for data stored in the personal data store of the entity. These and various other embodiments and advantages of the capability for providing a privacy-aware personal data store may be better understood when considered within the context of an exemplary communication system including a privacy-aware personal data store configured to securely store and control access to data from connected end devices, as depicted in FIG. 1.

FIG. 1 depicts an exemplary system including a privacy-aware personal data store configured to securely store and control access to data from connected end devices.

The system 100 is configured to provide privacy-aware personal data storage for an entity (e.g., a user 101 as illustrated in FIG. 1, a group of users, an institution, an organization, or the like, as well as various combinations thereof). The system 100 includes a set of connected end devices (CEDs) 105₁-105_{D} (collectively, CEDs 105) and a personal data storage (PDS) 107, which are associated with a premises 110 of the user 101. The premises 110 of the user 101 may be a home, a business location, or any other suitable environment in which privacy-aware personal data storage may be supported for CEDs associated with the environment. The system also includes a communication network (CN) 120 and a set of application servers (ASs) 130₁-130_{S} (collectively, ASs 130).

The CEDs 105 include devices configured to produce data 106 and communicate the data 106 (e.g., to other devices via communication networks or other types of communication paths, such as to network servers, end user devices, other connected end devices, or the like). The CEDs 105 may include various types of connected end devices, such as smart devices (e.g., smartphones, ubiquitous computing devices, or the like), Internet-of-Things (IoT) devices (e.g., smart objects, sensors, implants, or the like), or the like, as well as various combinations thereof. For example, CEDs 105 may include object tags attached to or otherwise associated with physical objects, sensors (e.g., temperature sensors, proximity sensors, or the like), detectors (e.g., motion detectors, carbon monoxide detectors, or the like), actuators (e.g., automatic door actuators, television lift actuators, or the like), controllers (e.g., gas valve controllers, mass flow controllers, or the like), or the like. For example, the CEDs 105 may include devices facilitating home automation where premises 110 is a home (e.g., smart alarm systems, touch screen door locks, smart garage door openers, security cameras, smart smoke and carbon monoxide detectors, smart thermostats, smart energy monitoring systems, smart appliances, smart home entertainment control systems, or the like). For example, the CEDs 105 may include devices facilitating workplace automation where premises 110 is a workplace (e.g., smart alarm systems, touch screen door locks, security cameras, smart thermostats, smart energy monitoring systems, or the like). For example, the CEDs 105 may include devices facilitating factory automation where premises 110 is a factory (e.g., gas valve controllers, mass flow controllers, or the like). The CEDs 105 may include various other types of connected end devices.

As discussed above, CEDs 105 are configured to produce data 106. The CEDs 105₁-105_{D} produce data 106₁-106_{D} (collectively, data 106). The data 106 produced by a CED 105 typically includes data produced by or about the entity or entities with which the CED 105 is associated (illustratively, user 101, although it will be appreciated that the entity or entities may be a groups of users (e.g., a family at a home, employees at a business, or the like), an organization, or the like); however, it will be appreciated that data 106 produced the CEDs 105 also may include other types of data. The data 106 produced by CEDs 105 may be considered to be personal data (and, thus, also may be referred to as personal data 106) that is personal to the entity or entities with which the CEDs 105 are associated (again, user 101 within the context of FIG. 1). Within the context of FIG. 1, for example, a proximity sensor may produce indications of movements of user 101 at the premises 110, a smart thermostat may produce data indicative of the temperatures and humidity levels experienced by the user 101 at the premises 110, a smart energy monitoring device may produce data indicative of the energy consumption by the user 101 at the premises 110, and so forth. The types of data 106 typically produced by different types of CEDs 105 will be understood by one skilled in the art.

As discussed above, CEDs 105 are configured to communicate the data 106. The CEDs 105 propagate the data 106 to PDS 107 for storage in PDS 107. The CEDs 105 propagate the data 106 to PDS 107 for storage in PDS 107 instead of propagating the data 106 to elements that otherwise would be intended destinations for (and, thus, consumers of) the data 106 in the absence of PDS 107 (which may be different for different CEDs 105). For example, the intended destinations for the data 106 produced by the CEDs 105 may be network servers (e.g., application servers such as ASs 130, Internet of Things (IoT) servers, or the like), a smartphone of the user 101, or the like, as well as various combinations thereof. The propagation of the data 106 to PDS 107, rather than to elements that otherwise would be intended destinations for the data 106 in the absence of PDS 107, secures the data 106 produced by the CEDs 105. The PDS 107 may then control access to the data 106 stored by PDS 107 by entities outside of premises 110 (e.g., elements that otherwise would have been the intended destinations for the data 106 in the absence of PDS 107, by other entities or elements, or the like, as well as various combinations thereof), as discussed further below. The PDS 107 may control access to the data 106 based on data access control information configured on the PDS 107 (e.g., by user 101 or by elements of CN 120 on behalf of user 101) configured for use by PDS 107 in controlling access by external entities to the data 106 stored on the PDS 107. The PDS 107 may control access to the data 106 stored by PDS 107 under control of user 101 (e.g., user 101 may control which external entities can access data 106, portions of the data 106 which may be accessed by external entities, purposes for which portions of the data 106 may be accessed by external entities, and so forth). This may result in a “privacy-by-design” capability that provides user 101 a much higher degree of control over his or her data 106, thereby enabling the user 101 to become the only true owner of the data 106. Furthermore, storage of the data 106 by the PDS 107 directly enables the user 101 to expose his or her data to a larger number of potential data consumers (e.g., entities other than those for which the data 106 may originally have been intended), thereby providing the user 101 with increased flexibility in the use of the data 106 and, thus, bringing increased value to the user 101. This may allow the user 101 to seek remuneration for making data 106 of PDS 107 available to external entities. For example, an eternal entity may propose a remuneration for the user 101 if the user provides access to data 106 of PDS 107 (or a specific portion of data 106 of PDS 107, such as a particular data type or the like), the user 101 may be presented with the proposal of the external entity and decide whether to accept the proposal, and the access rights of the external entity may be set based on the decision of the user 101 as to whether or not to accept the proposal. For example, the user 101 may configure PDS 107 to publish availability of data 106 of PDS 107 in exchange for remuneration being provided to the user 101, various external entities may access the published availability of data 106 of PDS 107 and, based on a determination that an external entity has indicated a request to access available data and has provided the required remuneration to user 101, the access rights of the external entity may be set such that the external entity may then access the data 106 of PDS 107 for which the user 101 was remunerated. It will be appreciated that remuneration may be provided in other ways.

The PDS 107 is configured to receive and securely store the data 106 produced by CEDs 105. The PDS 107 stores the data 106 produced by CEDs 105 without propagating the data 106 to elements that otherwise would be intended destinations for the data 106 (e.g., network servers associated with the CEDs which may be the intended consumers of the data 106 produced by the CEDs 105, as discussed above), as PDS 107 is configured to control further propagation of the data 106 produced by CEDs 105. The data 106 of the CEDs 105 that is stored by PDS 107 may be the raw data produced by CEDs 105. As discussed above, the types of data 106 stored by PDS 107 depend on the types of data 106 produced by CEDs 105, which may vary for different types of CEDs 105, different CEDs 105, or the like. For example, data 106 of the CEDs 105 may include readings from sensors, measurements from sensors, indicators from detectors or actuators, preference information from entertainment control devices, or the like. The storage by PDS 107 of data 106 produced by CEDs 105 may be performed based on data storage rules configured on PDS 107 for controlling storage of data 106 produced by CEDs 105. The storage of data 106 by PDS 107 may be organized in various ways, as discussed further below.

In at least some embodiments, for each of the CEDs 105, a device storage space is created for the CED 105 and, within the device storage space created for the CED 105, one or more data type storage spaces are created for one or more data types available from the CED 105. For example, where premises 110 includes a smart thermostat that is capable of collecting temperature, humidity, and user presence data, a device storage space is created for the smart thermostat and then three data type storage spaces are created within the device storage space for the smart thermostat (namely, a first data type storage space for storing temperature readings collected by the smart thermostat, a second data type storage space for storing humidity readings collected by the smart thermostat, and a third data type storage space for storing user presence information collected by the smart thermostat).

In at least some embodiments, for each device type of the set of CEDs 105, a device type storage space is created for the device type and, within the device type storage space created for the device type, one or more device storage spaces are created for one or more CEDs 105 that belong to that device type. For example, where premises 110 includes three energy monitoring devices for monitoring electric, solar, and gas usage at premises 110, a device type storage space is created for the set of energy monitoring devices and then three device storage spaces are created within the device type storage space for the set of energy monitoring devices (namely, a first device storage space for storing information related to monitoring of electric usage, a second device storage space for storing information related to monitoring of solar usage, and a third device storage space for storing information related to monitoring of gas usage).

It will be appreciated that the data storage spaces used to store data 106 of CEDs 105 may be organized using various storage structures (e.g., folders, files, linked memory locations, or the like, as well as various combinations thereof), which may depend on the type of storage element(s) used to store the data 106 of the CEDs 105. For example, in continuation of the smart thermostat example discussed above, the device storage space for the smart thermostat may be a folder, the data type storage spaces may be files within the folder, and the readings of the different data types may be entries within the files, respectively. For example, in continuation of the energy monitoring devices example discussed above, the device type storage space for the set of energy monitoring devices may be a folder, the device storage spaces may be subfolders within the folder having respective files stored therein, and the data produced by the energy monitoring devices may be entries within the files, respectively.

It will be appreciated that, although primarily presented with respect to storage of the data 106 using two or three hierarchical data storage levels, storage of the data 106 may use fewer or more hierarchical data storage levels.

It will be appreciated that, although primarily presented with respect to embodiments in which data 106 of the CEDs 105 that is stored by PDS 107 may be the raw data produced by CEDs 105, in at least some embodiments the PDS 107 may be configured to process the data 106 received from the CEDs 105 to form processed data (e.g., averages of measurements from temperature sensors, average energy consumption information from an energy monitor, user content preference information inferred from processing of user content control information, or the like) and to store the processed data.

The PDS 107 is configured to control access to and sharing of data 106 stored by PDS 107. The PDS 107 also may be configured to store data access metadata describing accessing of data 106 of the CEDs 105 that is securely stored by PDS 107 (e.g., read/write operations performed on the stored data, frequencies of read/write operations performed on the stored data, devices or entities which perform read/write operations performed on the stored data, or the like, as well as various combinations thereof).

The PDS 107 is configured to operate as a gateway between premises 110 of the user 101 (including the CEDs 105 associated with the premises 110) and elements located outside of the premises 110 (e.g., elements of CN 120, ASs 130, or the like). The operation of PDS 107 as a gateway protects the data 106 from CEDs 105 that is maintained by PDS 107 while also supporting controlled sharing of various portions of the data 106 outside of PDS 107 (as discussed further below). It will be appreciated that deployment of PDS 107 within the premises 110 of the user 101 provides the user 101 with a higher degree of control and protection over his or her data 106 (without compromising sharing of such data 106, as discussed further below), especially given that the communication of the data 106 of the CEDs 105 to the PDS 107 is local to the premises 110.

The PDS 107 may include a controller 108 and a storage element 109. The controller 108 is configured to provide various control functions described herein as being provided by PDS 107. For example, controller 108 may be configured to process the data 106 received from CEDs 105 for storage in storage element 109, respond to requests for access to data 106 stored in storage element 109 (e.g., requests from user 101, requests from elements located outside of premises 110 (e.g., ASs 130 or other external elements which may request access to or sharing of data stored by PDS 107), and so forth, or the like, as well as various combinations thereof. The storage element 109 is configured to securely store the data 106 from CEDs 105. The storage element 109 may be non-volatile memory, a database, or the like, as well as various combinations thereof. It will be appreciated that PDS 107 may be implemented in other ways while still providing various functions presented herein as being supported by PDS 107.

The CN 120 is configured to facilitate use of PDS 107 to securely store and to control access to data 106 of CEDs 105.

The CN 120 is operated by a network operator(s) which may act as a data broker for data 106 stored in PDS 107. For example, the network operator(s) may be an Internet Service Provider(s) or any other suitable type of network operator. The CN 120 may include various elements which may provide various data brokering functions for data 106 of the CEDs 105 that is stored in PDS 107. As depicted in FIG. 1, such elements may include a Personal Address Registry Module (PARM) 121, a Coordination Module (CM) 123, and a Configuration Module (CM) 124.

The PARM 121 is configured to provide registration and namespace management services for PDSs (namely, for PDS 107 as well as any other PDSs associated with user premises served by CN 120). The PDS 107 registers with PARM 121 and receives a unique personal address assigned to the PDS 107 by PARM 121 (or is registered with PARM 121 by user 101 and user 101 receives the unique personal address which the user 101 may then associate with the PDS 107). As depicted in FIG. 1, PARM 121 maintains a personal address registry 122 that maintains mapping information which includes a mapping of PDS 107 to the personal address assigned to the PDS 107 (as well as for any other PDSs associated with user premises served by CN 120). As discussed further below, the personal address assigned to PDS 107 allows entities outside of premises 110 to communicate with PDS 107 (e.g., other entities of CN 120 which provide data brokering for PDS 107, ASs 130 or any other entities which may request access to data 106 of PDS 107, or the like).

The CM 123 is configured to coordinate access to and control over data stored in PDSs (namely, for PDS 107 as well as any other PDSs associated with user premises served by CN 120). The CM 123 is configured to enable entities outside of premises 110 to access data 106 stored in PDS 107 (e.g., ASs 130 or any other entities which may request access to data 106 of PDS 107), which may include providing such entities with information required to reach and access the data 106 stored in PDS 107. In at least some embodiments, when an entity outside of premises 110 needs or wants to access data 106 stored in PDS 107, based on a determination that user 101 authorizes access by the entity to data 106 stored in PDS 107, the personal address of PDS 107 is provided to the entity (e.g., by the user 101, automatically by PDS 107, automatically by CM 123, or the like) and the entity may then contact the CM 123 using the personal address of PDS 107 in order to reach the PDS 107.

The CM 124 is configured to control configuration of CEDs to communicate with and store data within associated PDSs (namely, for CEDs 105 associated with PDS 107, as well as for other groups of CEDs associated with any other PDSs associated with user premises served by CN 120). In at least some embodiments, when a new CED 105 needs or wants to connect to PDS 107, the new CED 105 may (1) contact CM 124 in order to retrieve information which may be used by the new CED 105 to connect to PDS 107 and store data 106 within PDS 107 and (2) use the retrieved information to connect to the PDS 107 such that the new CED 105 may then store data 106 within the PDS 107.

It will be appreciated that, although primarily presented with respect to embodiments in which data brokering functions for data 106 stored in the PDS 107 are provided by a network operator, data brokering functions for data 106 stored in the PDS 107 may be provided by various other entities (e.g., data brokering management entities which may provide such functions by partnering with network operator(s), data brokering management entities which may provide such functions using a virtualized solution which may be hosted in a datacenter(s) or other virtualized environment, or the like, as well as various combinations thereof).

The ASs 130 may be configured to access data stored in PDSs (namely, for PDS 107 as well as any other PDSs associated with user premises served by CN 120). The ASs 130 may be configured to access data 106 stored in PDS 107 based on data access control information maintained by PDS 107 (which, as discussed herein, may be set by user 101 such that user 101 may control access to data 106 stored in PDS 107). The ASs 130 may access data 106 stored in PDS 107 using the personal address assigned to the PDS 107. The ASs 130 may send requests to access data 106 of PDS 107 to PDS 107 indirectly (e.g., by directing the request to CM 123 which, as discussed above, is configured to coordinate access to and control over data stored in PDSs) or directly (e.g., without directing the request to CM 123 or any other data brokering element). The use of PDS 107 to securely store data 106 of CEDs 105 prevents the ASs 130 from received or accessing the data 106 from the CEDs 105 directly, thereby enhancing the security of the data 106 for user 101.

The operation of system 100 may be better understood by way of a simple example. Assume that user 101 buys a new CED 105 (e.g., a smart weight scale) and configures the new CED 105 in order to specify data from the new CED 105 that is to be stored by PDS 107 (and, optionally, the data storage structure for the data of the new CED 105 that is to be stored in PDS 107). The user 101 provides the personal address of PDS 107 to the new CED 105 in order to associate the new CED 105 with the PDS 107. The new CED 105 then provides the specified data to PDS 107 for storage by PDS 107 (which, as noted above, may be based on the data storage structure specified for the data of the new CED 105 that is to be stored in PDS 107).

It will be appreciated that, although primarily presented with respect to embodiments in which PDS 107 stores specific types of data from CEDs 105, in at least some embodiments PDS 107 may be used by user 101 to store various other types of data which may be provided from various other types of devices. In at least some embodiments, user 101 may intentionally store various types of content on PDS 107 (e.g., audio, images, videos, or the like, as well as various combinations thereof). In this manner, PDS 107 could be used by the user as a multimedia hub for storing and managing various types of content. It will be appreciated that, in at least some such embodiments, PDS 107 also may be configured to control access to the content stored on PDS 107 (e.g., controlling access to such content by applications such as home entertainment applications, online social network applications, or the like). Thus, it will be appreciated that various functions of system 100 presented herein may be applied to various other types of data which may be provided from various other types of devices.

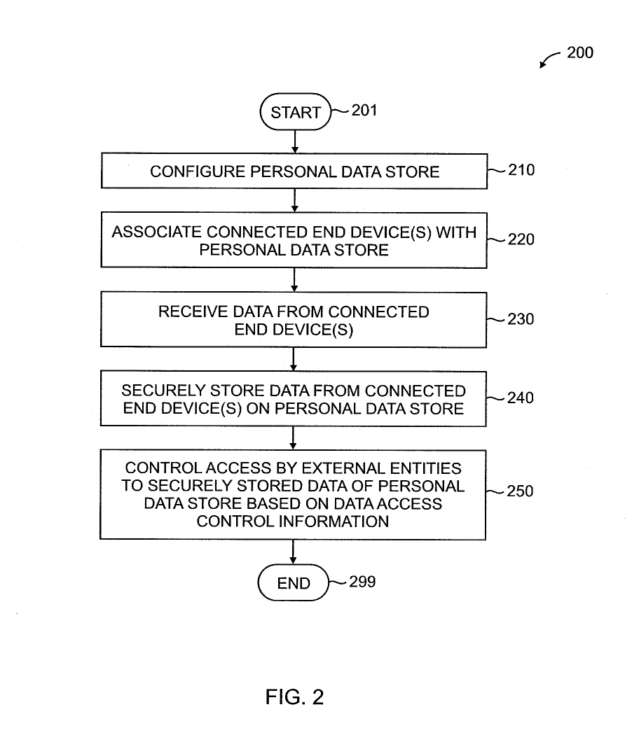

FIG. 2 depicts an exemplary embodiment of a method for using a privacy-aware personal data store to securely store and control access to data from connected end devices. It will be appreciated that, although depicted and described as being performed serially, at least a portion of the steps of method 200 may be performed contemporaneously or in a different order than as depicted in FIG. 2. At step 201, method 200 begins. At step 210, the personal data stores configured. At step 220, a connected end device(s) is associated with the personal data store. At step 230, data is received from the connected end device(s). At step 240, data from the connected end device(s) is securely stored on the personal data store. At step 250, access by external entities to securely store data of the personal data store is controlled based on data access control information. At 299, method 200 ends. It will be appreciated that the various steps of method 200 may be better understood when considered in conjunction with the description of FIG. 1.

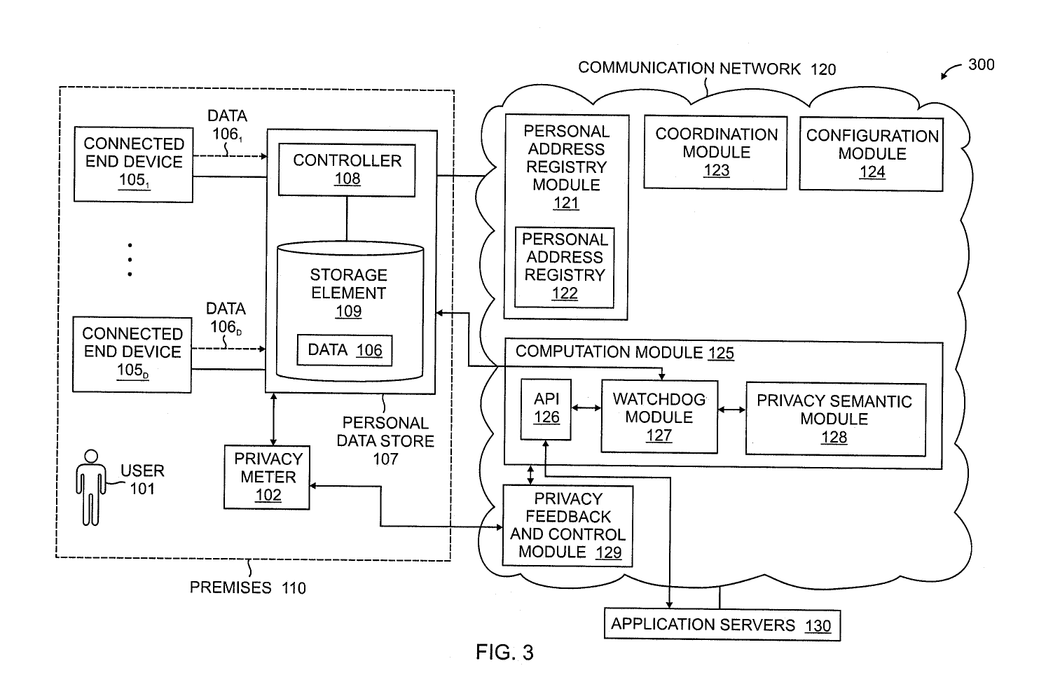

Referring back to FIG. 1, it is noted that, in at least some embodiments, system 100 may be configured to support privacy monitoring, feedback, and control capabilities, thereby enabling users to have better awareness of and control over data privacy. An exemplary system modification of system 100 of FIG. 1 to support privacy monitoring, feedback, and control capabilities is depicted in FIG. 3.

FIG. 3 depicts an exemplary system, including a privacy-aware personal data store, configured to support privacy monitoring, feedback, and control capabilities for the privacy-aware personal data store. As noted above, system 300 of FIG. 3 is a modified version of system 100 of FIG. 1. The system 300 of FIG. 3 is identical to the system 100 of FIG. 1, while also including a Computation Module (CM) 125, a Privacy Feedback and Control Module (PFCM) 129, and a Privacy Meter (PM) 102.

The CM 125 is configured to operate as a gateway between PDS 107 and entities that need or want access to data 106 stored by PDS 107 (e.g., ASs 130 or any other suitable entities). The CM 125 is configured to provide a secure platform over which data stored by PDS 107 may be accessed and used by ASs 130.

The CM 125 includes an Access Point Interface (API) 126, a Watchdog Module (WM) 127, and a Privacy Semantic Module (PSM) 128. The API is configured to communicate with WM 127 and ASs 130. The WM 127 is configured to communicate with API 126, PSM 128, and PDS 107. The PSM 128 is configured to communicate with WM 127.

The API 126 controls data description metadata, which provides a description of data stored in PDSs (namely, for PDS 107 as well as any other PDSs associated with premises served by CN 120). The API 126 maintains data description metadata for data 106 stored in PDS 107. The API 126 may obtain the data description metadata for data 106 stored in PDS 107 from PDS 107 (e.g., provided by PDS 107 periodically or on an event-driven basis, requested by API 126 periodically or on an event-driven basis, or the like, as well as various combinations thereof). The API controls distribution of the data description metadata. The API 126 provides the data description metadata for data 106 stored in PDS 107 to ASs 130. The ASs 130 may use the data description metadata for data 106 stored in PDS 107 in order to subscribe to data 106 available from PDS 107. The subscription of an AS 130 may be a form of a contract between the PDS 107 and the AS 130 subscribing to the data 106 from the PDS 107.

The WM 127 is configured to monitor data subscriptions by ASs 130 to data stored in PDSs (namely, for PDS 107 as well as any other PDSs associated with user premises served by communication network 120). The WM 127 also may be configured to gather information about such data subscriptions, such as mappings of data types to sets of ASs 130 with subscriptions to those respective data types, mappings of ASs 130 to data types subscribed to by those respective ASs 130, the intended purposes of the data subscriptions, or the like, as well as various combinations thereof. The WM 127 also may be configured to obtain publically available information (e.g., from the Internet or other public sources of such information) regarding devices (e.g., CEDs 105) and applications (e.g., ASs 130) and to use such information in order to monitor for and detect privacy threats or potential privacy threats for data stored by PDSs. For example, for a given data subscription in which an AS 130 that hosts a particular application subscribes to data 106 from a CED 105, WM 127 may obtain publically available information regarding that type of CED 105 and that particular AS 130 and use such information to determine whether there is a privacy threat or potential privacy threat due to that subscription by the AS 130 to the data 106 of that CED 105 that is maintained by PDS 107. The WM 127 is configured to provide information regarding devices and applications to PSM 128. The WM 127 also may be referred to herein as a privacy threat evaluation module.

The PSM 128 may be configured to estimate privacy levels related to data 106 stored in PDS 107. The PSM 128 may be configured to estimate the privacy level of a CED 105 (which also may be considered to be an estimate of the privacy level of portions of data 106 maintained by PDS 107 that were received from the CED 105). The PSM 128 may be configured to estimate the privacy level of a CED 105 based on one or more of privacy settings of the user 101 (e.g., which may be maintained by PSM 128 or otherwise obtained by PSM 128), the data 106 of the CED 105 that is being used by AS(s) 130, the AS(s) 130 using data 106 of the CED 105, or the like, as well as various combinations thereof. The PSM 128 may estimate privacy levels based on a set of machine learning algorithms. The PSM 128 may be configured to estimate the privacy level of a CED 105 by monitoring one or more features regarding access level of data from the CED 105 and then processing the information obtained from monitoring of such features to estimate the privacy level of the CED 105. The features that may be monitored may include one or more of the sampling frequency of the CED 105 (e.g., how often a sample reading is taken and reported by the CED 105, how often information is propagated from the CED 105, or the like), data storage duration information (e.g., information indicative as the length of time for which data 106 of the CED 105 is stored in PDS 107), a number of ASs 130 having access to the data 106 of the CED 105 that is stored in PDS 107, a number of other data sources (e.g., internal data sources such as other CEDs 105, external data sources, or the like) for which data 106 of the CED 105 is merged with data of the other data sources, or the like, as well as various combinations thereof. It will be appreciated that, although primarily depicted and described with respect to embodiments in which PSM 128 is configured to estimate the privacy level of a CED 105, PSM 128 may be configured to estimate privacy levels at various other granularities (e.g., PSM 128 may be configured to estimate the privacy level for a particular type of data maintained by PDS 107 for a given CED 105, a particular type of data maintained by PDS 107 across each CED 105 that is associated with PDS 107 and for which the particular type of data is maintained by PDS 107, for a subset of CEDs 105 associated with PDS 107 (e.g., based on CED types of CEDs 105 (e.g., all CEDs 105 that are sensors, all CEDs 105 that are actuators, or the like), based on data types stored by particular CEDs 105 in the subset of CEDs 105, or the like), for all of the CEDs 105 of the PDS 107 as a whole (which also may be considered to be the privacy level for the premises 110 or for the user 101), or the like, as well as various combinations thereof). The PSM 128 may be configured to provide information indicative of the privacy level of a CED 105 to the PFCM 329, for use by PFCM 329 in providing privacy level visualization and control functions as discussed further below. As indicated above, the privacy level of a CED 105 or group of CEDs 105 also may be considered to be the privacy level of the data 106 of the CED 105 or group of CEDs 105. The PSM 128 also may be referred to herein as a privacy level estimation module.

The PFCM 129 may be configured to provide visual indicators which are indicative of privacy levels of data 106 stored in PDS 107. The PFCM 129 may be configured to provide visual indicators which are indicative of the privacy level of a CED 105 (which also may be considered to be visual indicators of the privacy level of portions of data 106 maintained by PDS 107 that were received from the CED 105). The PFCM 129 may be configured to propagate the visual indicators which are indicative of the privacy levels of data 106 stored in PDS 107 to the PM 102, which supports presentation of and control over the privacy levels of data 106 stored in PDS 107, as discussed further below. The visual indicators which may be provided by PFCM 129 are described in additional detail below in conjunction with descriptions of presentation of the visual indicators by PM 102.

The PM 102 may be configured to support presentation of and control over privacy levels related to data 106 stored in PDS 107. The PM 102 may be configured to support presentation of and control over the privacy level of a CED 105 (which also may be considered to be presentation of and control over the privacy level of portions of data 106 maintained by PDS 107 that were received from the CED 105). The PM 102 for the CED 105 allows user 101 to easily visualize and control the privacy level of the CED 105. The PM 102 for the CED 105 may allow the user 101 to dynamically and seamlessly review and set the privacy level of the CED 105, thereby enabling the user 101 to control which data 106 of the CED 105 stored by PDS 107 may be accessed by entities external to premises 110 (e.g., ASs 130 or other suitable external entities).

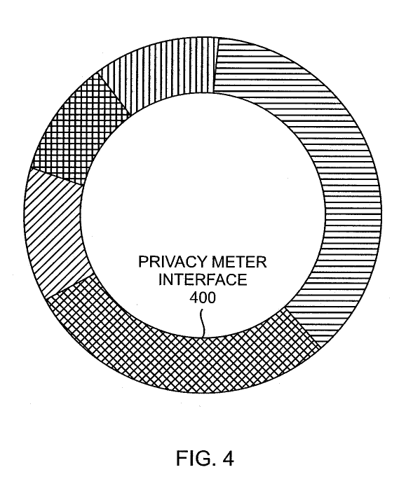

The PM 102 for a CED 105 may be implemented in various ways. The PM 102 for a CED 105 may provide one or more presentation and control interfaces which may be used for presentation of and control over privacy levels related to data 106 of the CED 105 that is stored in PDS 107, where it will be appreciated that implementation of the one or more presentation and control interfaces of the PM 102 may be dependent upon the manner in which PM 102 is implemented. The PM 102 for a CED 105 may be implemented as one or more modules stored on the CED 105, as an object or device that is integrated as part of the CED 105 (e.g., a control interface integrated into the CED 105), as a standalone object or device that is external to the CED 105 and which may be communicatively connected to the CED 105 (e.g., via a communication port of the CED 105) or directly to the PDS 107, or the like. For example, where the PM 102 is implemented as one or more modules stored on the CED 105, the PM 102 may be accessed via one or more existing interfaces of the CED 105 which may depend on the device type of the CED 105 (e.g., one or more of a touch screen interface of the CED 105, buttons and a display screen of the CED 105, or the like, as well as various combinations thereof). For example, where the PM 102 for a CED 105 is implemented as an object or device that is integrated as part of the CED 105, the PM 102 may be accessed via one or more interfaces of the CED 105 or one or more interfaces of the PM 102, where such interfaces may include one or more touch screen interfaces, one or more buttons or dials, or the like, as well as various combinations thereof. For example, where the PM 102 for a CED 105 is implemented as a standalone object or device that is external to the CED 105 and which may be communicatively connected to the CED 105 or directly to the PDS 107, the interfaces of the PM 102 include one or more of a display interface, a touch screen interface, one or more buttons, one or more dials, or the like, as well as various combinations thereof. In at least some embodiments, the PM 102 may be implemented as a smartphone application, such that the user 101 may see and control the privacy level of the data 106 of the CED 105 via his or her smartphone. In at least some embodiments, the PM 102 may be a wearable object or device (e.g., a privacy ring having LEDs for indicating the privacy level of the data of the CED 105 and a privacy dial which may be turned for controlling the privacy level of the data 106 of the CED 105, a pair of smart glasses, or the like). The presentation and control interface(s) of PM 102 may be implemented using various form factors, at least some of which may integrate presentation of and control over privacy levels of the data 106 of the CED 105. For example, the presentation and control interface of PM 102 may be a linear graphical display where different portions of the linear interface corresponding to different portions of data 106 of the CED 105 stored by PDS 107 may be displayed using different colors to represent different privacy levels and the privacy levels of the portions of the data 106 may be controlled by the user 101 by tapping on those portions of the linear interface. For example, the presentation and control interface of PM 102 may be a circular graphical display where different portions of the circular interface corresponding to different portions of data 106 of the CED 105 stored by PDS 107 may be displayed using different colors to represent different privacy levels and the privacy levels of the portions of the data 106 may be controlled by the user 101 by sliding his or her finger in different directions along the portions of the circular interface (an exemplary embodiment of which is depicted as privacy meter interface 400 of FIG. 4). The presentation and control interface(s) of PM 102 may be implemented in various other ways.

The PM 102 may be configured to support presentation of the privacy level of a CED 105. The PM 102 may be configured to present the privacy level of a CED 105 via presentation of one or more visual indicators. The visual indicators may be received from PFCM 129 or determined by PM 102 based on information received from PFCM 129. The PM 102 may provide visual indicators which are indicative of the privacy level of a CED 105 using various types of indicators (e.g., icons, shading, colors, or the like). For example, an indicator indicative of the privacy level of a CED 105 may be green as long as no threat is detected, may transition from green to yellow when a potential threat is detected, and may transition from green or yellow to red when an actual threat is detected. It will be appreciated that various other numbers and types of colors may be used. The PM 102 may provide visual indicators via various types of indicator interfaces (e.g., graphical display screens, light emitting diodes (LEDs), or the like, as well as various combinations thereof).

The PM 102 may be configured to support control over the privacy level of a CED 105. The PM 102 may be configured to support control over the privacy level of a CED 105 using various user interaction capabilities (e.g., point-and-click capabilities, touch screen or touch surface capabilities, voice-based control capabilities, or the like, as well as various combinations thereof). The PM 102, responsive to control inputs received via user interaction capabilities for a CED 105, may communicate the control inputs to PDS 107 for modification of various settings of the PDS 107 related to privacy for data 106 of the CED 105 stored by the PDS 107 (e.g., high level pre-defined privacy settings, the data 106 of the CED 105 which may be shared, the ASs 130 with which data 106 of the CED 105 may be shared, or the like, as well as various combinations thereof). It will be appreciated that the communication of control inputs from the PM 102 to PDS 107 for controlling the privacy level of the CED 105 may be via PFCF 329 or may be independent of PFCF 329 (e.g., directly from the CED 105 to the PDS 107 where PM 102 is displayed and accessed on the CED, from an external device to the PDS 107 where PM 102 is displayed and accessed on the external device, from a smartphone of user 101 to the PDS 107 where PM 102 is displayed and accessed via an application on the smartphone of the user 101, or the like, as well as various combinations thereof).

It will be appreciated that, although primarily depicted and described with respect to embodiments in which PM 102 is configured to provide visualization of and control over the privacy level of a CED 105, PM 102 may be configured to provide visualization of and control over privacy levels at various other granularities (e.g., PM 102 may be configured to provide visualization of and control over privacy levels for a particular type of data maintained by PDS 107 for a given CED 105, a particular type of data maintained by PDS 107 across each CED 105 that is associated with PDS 107 and for which the particular type of data is maintained by PDS 107, for a subset of CEDs 105 associated with PDS 107 (e.g., based on CED types of CEDs 105 (e.g., all CEDs 105 that are sensors, all CEDs 105 that are actuators, or the like), based on data types stored by particular CEDs 105 in the subset of CEDs 105, or the like), for all of the CEDs 105 of the PDS 107 as a whole (which also may be considered to be provide visualization of and control over privacy levels for the premises 110 or for the user 101), or the like, as well as various combinations thereof). As indicated above, the presentation of and control over the privacy level of a CED 105 or group of CEDs 105 also may be considered to be presentation of and control over the privacy level of the data 106 of the CED 105 or group of CEDs 105.

It will be appreciated that, although primarily presented with respect to embodiments in which PSM 128, PFCM 129, and PM 102 are configured to provide various functions related to privacy level, PSM 128, PFCM 129, and PM 102 may be configured to provide such functions for other types of metrics (e.g., privacy risk, security level, security risk, exposure level, exposure risk, threat level, threat risk, or the like, as well as various combinations thereof).

It will be appreciated that, although primarily depicted and described with respect to embodiments in which application servers request access to or subscribed to data of the PDS 107, it will be appreciated that various other types of devices may request access to or subscribed to data of the PDS 107 (e.g., other types of network elements, end user devices, other connected end devices (e.g., for M2M communications), or the like).

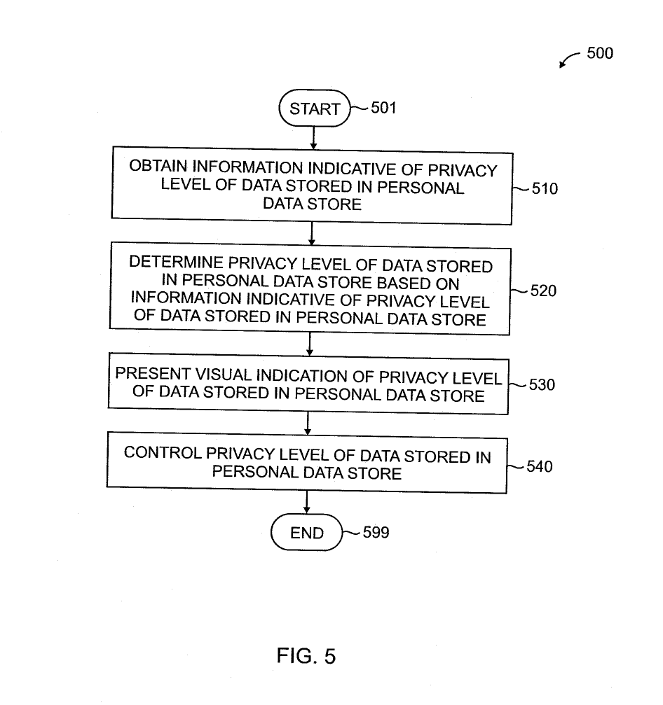

FIG. 5 depicts an exemplary embodiment of a method for supporting privacy monitoring, feedback, and control capabilities for a privacy-aware personal data store. It will be appreciated that, although depicted and described as being performed serially, at least a portion of the steps of method 500 may be performed contemporaneously or in a different order than as depicted in FIG. 5. At step 501, method 500 begins. At step 510, information indicative of the privacy level of data stored in the personal data store is obtained (e.g., for all data of the personal data store, for a subset of data associated with a group of CEDs, for a subset of data associated with a specific CED, or the like). At step 520, a privacy level of data stored in the personal data store is determined based on the information indicative of the privacy level of data stored in the personal data store. At step 530, a visual indication of the privacy level of data stored in the personal data store is presented. The visual indication of the privacy level of data stored in the personal data store may be presented via a smartphone or other device, a privacy meter, or any other suitable user interface. At step 540, the privacy level of data stored in the personal data store is controlled. The privacy level of data stored in the personal data store may be controlled via a smartphone or other device, a privacy meter, or any other suitable user interface. At 599, method 500 ends. It will be appreciated that the various steps of method 500 may be better understood when considered in conjunction with FIGS. 1 and 3.

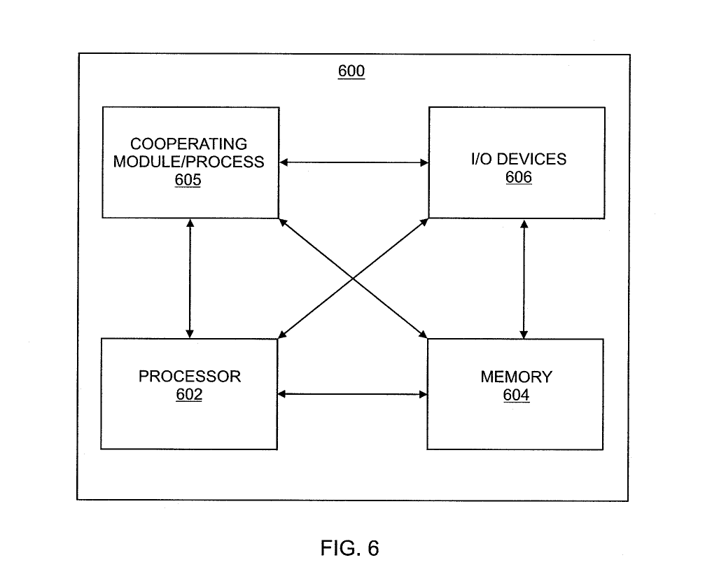

FIG. 6 depicts a high-level block diagram of a computer suitable for use in performing functions described herein.

The computer 600 includes a processor 602 (e.g., a central processing unit (CPU) and/or other suitable processor(s)) and a memory 604 (e.g., random access memory (RAM), read only memory (ROM), and the like).

The computer 600 also may include a cooperating module/process 605. The cooperating process 605 can be loaded into memory 604 and executed by the processor 602 to implement functions as discussed herein and, thus, cooperating process 605 (including associated data structures) can be stored on a computer readable storage medium, e.g., RAM memory, magnetic or optical drive or diskette, and the like.

The computer 600 also may include one or more input/output devices 606 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 600 depicted in FIG. 6 provides a general architecture and functionality suitable for implementing functional elements described herein and/or portions of functional elements described herein. For example, the computer 600 provides a general architecture and functionality suitable for implementing one or more of a CED 105, PDS 107, controller 108, storage element 109, PARM 121, CM 123, CM 124, CM 125, API 126, WM 127, PSM 128, PFCM 129, PM 102, or the like, as well as various combinations thereof.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1. A personal data store, comprising:
a processor and a memory communicatively connected to the processor, the processor configured to:
receive, at the personal data store, data from a connected end device associated with a network server, the network server being an intended consumer of the data from the connected end device;
securely store the data from the connected end device in the personal data store; and
propagate at least a portion of the securely stored data from the personal data store toward the network server based on data access control information associated with the securely stored data.

2. The personal data store of claim 1, wherein the processor is configured to securely store the data from the connected end device using a storage hierarchy that is based on an organizational hierarchy of the connected end device.

3. The personal data store of claim 1, wherein the data from the connected end device comprises data of multiple data types, wherein the processor is configured to securely store the data from the connected end device using a storage hierarchy comprising:
a storage folder associated with the connected end device; and
a set of multiple data storage folders or files associated with the respective multiple data types.

4. The personal data store of claim 1, wherein the processor is configured to:
receive, from a second network server, a request to access at least a portion of the securely stored data; and
determine, based on the data access control information associated with the securely stored data, whether to grant access by the second network server to the requested portion of the securely stored data.

5. The personal data store of claim 1, wherein the processor is configured to:
propagate, toward a registry module, a request for assignment of a personal address to the personal data store;
receive the personal address assigned to the personal data store; and
associate the personal address with the personal data store.

6. The personal data store of claim 5, wherein the processor is configured to:
propagate the personal address assigned to the personal data store toward the network server for use by the network server in accessing the securely stored data.

7. The personal data store of claim 1, wherein the processor is configured to:
determine data description metadata describing storage of the securely stored data on the personal data store; and
propagate the data description metadata toward an element configured to control distribution of the data description metadata.

8. The personal data store of claim 1, wherein the processor is configured to:
determine data access metadata describing access, by the network server, to the securely stored data; and
propagate the data access metadata toward an element configured to determine a privacy level of the securely stored data.

9. The personal data store of claim 1, wherein the processor is configured to:
receive, from a privacy meter associated with the connected end device, a request to modify the data access control information associated with the securely stored data; and
modify the data access control information associated with the securely stored data based on the request to modify the data access control information associated with the securely stored data.

10. A method for use by a personal data store, the method comprising:
receiving, via a processor of the personal data store, data from a connected end device associated with a network server, the network server being an intended consumer of the data from the connected end device;
securely storing the data from the connected end device in the personal data store; and
propagating at least a portion of the securely stored data from the personal data store toward the network server based on data access control information associated with the securely stored data.

11. An apparatus configured to support a personal data store, the apparatus comprising:
a first module configured to control configuration of a connected end device to communicate with the personal data store and store data of the connected end device within the personal data store; and
a second module configured to control access to data of the connected end device stored in the personal data store.

12. The apparatus of claim 11, wherein the first module is configured to:
receive, from the connected end device, a request to connect to the personal data store; and
propagate, toward the connected end device, information configured for use by the connected end device to connect to the personal data store.

13. The apparatus of claim 11, wherein the second module is configured to:
receive, from a device, a request to access data of the connected end device stored in the personal data store; and
propagate, toward the device based on a determination that an entity controlling the personal data store has authorized access by the device to the data of the connected end device stored in the personal data store, information configured for use by the device to connect to the personal data store.

14. The apparatus of claim 13, wherein the information configured for use by the device to connect to the personal data store comprises a personal address assigned to the personal data store.

15. The apparatus of claim 11, further comprising:
a third module configured to operate as a gateway between the personal data store and a device attempting to access the data of the connected end device stored in the personal data store.

16. The apparatus of claim 15, wherein the third module comprises:
an application programming interface (API) configured to provide a description of the data of the connected end device stored in the personal data store;
a privacy threat evaluation module configured to monitor a data subscription by a device to data of the connected end device stored in the personal data store and to determine whether there is a privacy threat associated with the data subscription by the device to the data of the connected end device stored in the personal data store; and
a privacy semantic module configured to estimate a privacy level of the data of the connected end device stored in the personal data store.

17. The apparatus of claim 16, wherein the API is configured to:
propagate, toward the device, the data description metadata comprising a description of the data of the connected end device stored in the personal data store.

18. The apparatus of claim 16, wherein, to monitor the data subscription by the device to data of the connected end device stored in the personal data store, the privacy threat evaluation module is configured to:
obtain data subscription information comprising at least one of an indication of a data type subscribed to by the device or an intended purpose of the data subscription of the device;
obtain device description information comprising at least one of information describing the connected end device and information describing the device; and
determine, based on the data subscription information and the device description information, whether there is a privacy threat related to the data subscription by the device to the data of the connected end device stored in the personal data store.

19. The apparatus of claim 16, wherein, to estimate the privacy level of the data of the connected end device stored in the personal data store, the privacy semantic module is configured to:
receive, from the privacy threat evaluation module, data subscription information related to the subscription by the device to the data of the connected end device stored in the personal data store;
receive, from the privacy threat evaluation module, device description information comprising at least one of information describing the connected end device and information describing the device; and
estimate, based on the data subscription information and the device description information, a privacy level of the data of the connected end device stored in the personal data store.

20. A privacy meter, comprising:
a presentation interface configured to present a visual indicator indicative of a privacy level of data of a connected end device stored in a personal data store;
an interaction interface configured to accept an indicator of a modification of the privacy level of the data of the connected end device stored in the personal data store; and
a processor communicatively connected to the presentation interface and the interaction interface, the processor configured to:
receive, from a network element, an indication of the privacy level of the data of the connected end device stored in the personal data store and control presentation of the visual indicator indicative of the privacy level of data of the connected end device stored in the personal data store; and
receive the indicator of the modification of the privacy level of the data of the connected end device stored in the personal data store and propagate, toward at least one of the personal data store or the network element, a request for modification of the privacy level of the data of the connected end device stored in the personal data store.
